(19) United States
(12) Patent Application Publication
(10) Pub. No.: US 2007/0099502 A1
(43) Pub. Date: May 3, 2007

(54) Refrigerator housing

(75) Inventors: Adolf Ferinauer, Giengen (DE); Michael Neumann, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch and Siemens Hausgerate GmbH, Munich (DE)

(21) Appl. No.: 10/579,940

(22) PCT Filed: Nov. 24, 2004
(86) PCT No.: PCT/EP04/53071

§ 371 Date: May 19, 2006

(30) Foreign Application Priority Data
Nov. 26, 2003 (DE) 103 55 137.9

(51) Int. Cl. H01R 13/40

(52) U.S. Cl. 439/589

(57) ABSTRACT

The invention relates to a housing for a refrigerator comprising a body (1) and a door (2), which is fixed to the body (1), both of which define an inner chamber (8). The body (1) and the door (2) comprise at least one evacuated insulation body (3, 4, 5, 6, 11) which is separated from the inner chamber (8) by an inner wall (7, 15) made of a plastic material.

The present invention relates to a housing for a refrigerator. Housings of this type are generally composed of a body and a door hinged to the body, which jointly define an inner chamber for the storage of chilled goods. In most refrigerators the door and body each have an outer and an inner wall which are interconnected at their edges and enclose an interior space filled with a heat-insulating foam material. The inner wall which is generally deep-drawn from plastic material can be given a complex shape which allows internal attachments such as a shelves, door compartments or the like to be affixed thereto. It is also possible to provide apertures in the inner wall to fix attachments thereon.

It is also known to construct a refrigerator housing from vacuum insulation technology by evacuating the intermediate space between an inner and outer wall, e.g. made of stainless steel or plastic made suitably non-diffusive, so that it is heat-insulating. Such vacuum insulation is considerably more effective than a foam-air insulation so that a vacuum-insulated refrigerator having the same external dimensions and the same power consumption as a foam-air-insulated device can have a larger interior than the latter. In order to maintain the vacuum over the lifetime of the device, the walls must be non-diffusive which necessitates using metallic materials for the walls. It is extremely expensive to reliably construct such an inner wall in foam-air-insulated devices with a plastic inner wall so that attachments can be suspended thereon. Apertures on the wall surfaces of the inner cladding would destroy the vacuum tightness. Fixing elements required to attach internal attachments must therefore be attached by spot welding in which case the process parameters must also be exactly correct in order not to impair the tightness of the walls.

It is the object of the invention to provide a vacuum-insulated refrigerator housing which has the same flexibility with regard to the attachment of internal attachments as a conventional foam-insulated housing.

The object is solved by a housing having the features of claim 1. Since the inner wall defining the interior chamber is not formed by a wall of the vacuum-insulated insulation body but by a wall disposed in front thereof, the known tested techniques for application of internal attachments can be used thereon without endangering the tightness of the insulation body. Merely the possibility of being able to manufacture the plastic inner cladding by a non-cutting shaping method brings with it the advantage that the supporting strips and so on can be co-formed thereon. As a result of the combination of a housing and/or a door produced from vacuum insulation technology with an inner cladding formed by a non-cutting technique, it is possible to produce refrigerators which, with external dimensions corresponding to those of conventionally constructed devices, have a significantly improved heat insulation capacity whilst at the same time retaining the advantages of attaching internal attachments at favourable cost.

The insulation body is preferably separated from this inner wall and at least locally by an intermediate space. It is thereby possible to structure the inner wall three-dimensionally and, for example, form grooves or supporting strips therein for supporting the edges of a shelf.

The intermediate space between the inner wall and the insulation body is preferably foam-filled so that it contributes to the insulating effect of the housing. In contrast to the wall of the insulation body, the inner wall can easily be provided with an aperture which can especially be used to pass a cable therethrough or to anchor a holder for internal attachments thereon. Thus, for example, the cable can simply be guided as far as the location of the aperture between the vacuum-insulated housing and/or such a door and an inner cladding located in front thereof towards the inner chamber.

The body of the refrigerator is preferably composed of a plurality of plate-shaped insulation bodies and a one-piece inner wall which separates all the insulation bodies of the body from the inner chamber. In precisely this manner, it is possible to construct the body of the refrigerator in one piece from an inner cladding and an outer cladding connected in a vacuum-tight manner thereto, with interposed evacuable heat-insulating material used to support this cladding.

Further features and advantages of the invention are obtained from the following description of exemplary embodiments with reference to the appended figures. In the figures:

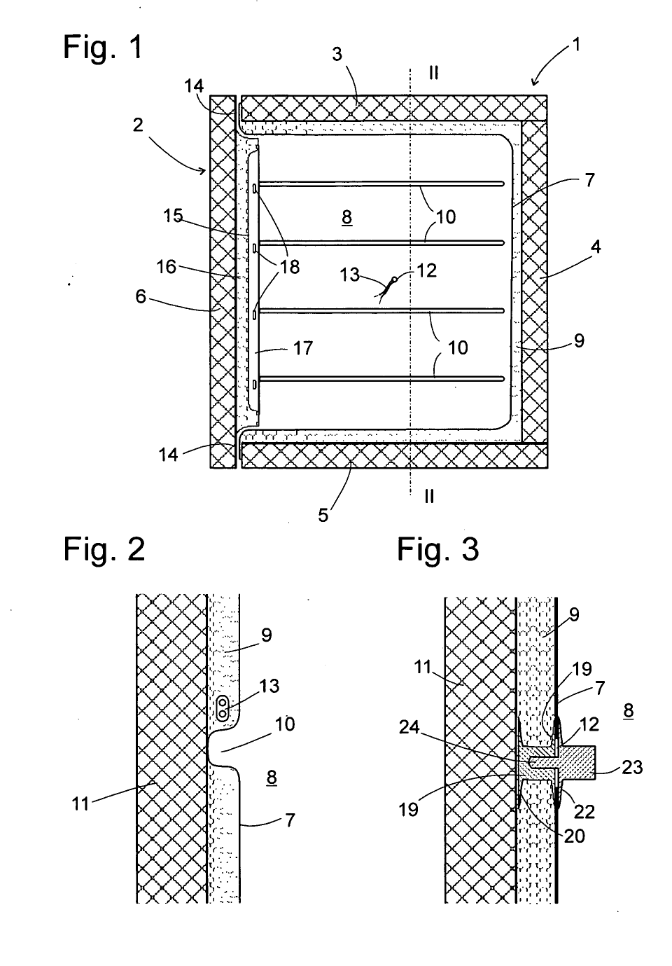

FIG. 1 is a schematic section through a first embodiment of a refrigerator housing according to the invention;

FIG. 2 is a section through the side wall of the refrigerator housing along the line II-II from FIG. 1; and

FIG. 3 is a section through a wall of a refrigerator body according to a second embodiment of the invention.

The refrigerator housing shown in a vertical section in FIG. 1 is composed in the present case of a plurality of plate-shaped vacuum insulation elements, each forming a top 3, a rear wall 4, a bottom 5 and two side walls of a body 1 which are not described in detail. Another plate-shaped vacuum insulation element 6 is constructed as a door 2. The plate-shaped vacuum insulation bodies 3, 4, 5, 6 of the top, the back, the bottom and the door are shown in section in the figure. The vacuum insulation bodies 3, 4, 5, 6 have a metal outer wall produced, for example, by non-cutting shaping and an intermediate wall at a distance therefrom, and are provided with a supporting material in the interior, such an open-pored foam, which allows the insulation bodies to be evacuated and prevents them from collapsing under the external atmospheric pressure.

Located between an inner wall 7 deep-drawn in one piece from plastic, which defines the interior chamber 8 of the refrigerator, and the inner walls of the vacuum insulation bodies 3, 4, 5 is an intermediate space 9 filled with insulating foam. In contrast to the supporting material, this can be a closed-pore foam whose pores contain a propellant gas used to expand the foam in the intermediate space. The inner wall 7 is provided with a plurality of horizontal grooves 10 which are provided to receive lateral edges of shelves (not shown) and thus support these. As a result of the adhesively-acting foam in the intermediate space 9, the inner wall 7 is imparted the required stiffness and bearing capacity and at the same time, the inner wall 7 is connected to the insulation bodies 3, 4 and 5.

FIG. 2 shows a partial section through a side wall of the body 1 at the height of such a groove 10. It can be seen that in the present exemplary embodiment the bottom of the groove 10 is in direct contact with a vacuum insulating body 11 of this side wall. A supporting core 9 which supports the inner wall 7 during the foaming process prevents the inner wall 7 from moving away from the insulation body 11 during the foaming of the intermediate space 9 and thus the volume of the inner chamber 8 being undesirably reduced. In precisely the same way, it is also possible for the groove to be back-foamed.

A cable 13 extends through a hole 12 cut in the inner wall 7, which can be used for example for supplying power for interior lighting, for connecting a temperature sensor or the like.

The door 2 has a similar structure to the body 1. Its outer side is completely formed by the vacuum insulation body 6; located at the edges 14 of its inner side is a plastic deep-drawn inner wall 15 which is at a distance from the insulation body 6 in its central area and projects a short distance into the open front side of the inner wall 7. The intermediate space 16 thereby formed between the vacuum insulation body 16 and the inner wall 15 is likewise filled with foam. As a result of the adhesive action of the foam, the inner wall 15 is constructed as rigid and connected to the insulation body 6. The inner wall 15 has a large-area recess 17 facing the inner chamber 8; projections 18 formed on the flanks of the inner wall 15 laterally surrounding the recess 17 are used to support door compartments suspended thereon in a manner known per se.

FIG. 3 shows a section similar to FIG. 2 through a side wall of a refrigerator according to a second embodiment of the invention. In this embodiment a spacer 19, has been initially attached, e.g. stuck on to the inside of the vacuum insulation body 11 before inserting the inner wall 7. The adhesion does not need to be permanent since it is no longer required in the finished refrigerator. The spacer 19 is fitted between a flange 20 in contact with the insulation body 11 and a flange 21 in contact with the inner wall 7 in order to keep the heat transfer through the spacer 19 low. The flange 21 is facing a hole 12 cut into the inner wall 7 and extends beyond the edges of the hole 12. A flange 22 of a holder portion 23 is located opposite to the flange 21 on the other side of the inner wall 7. A central pin 24 of the holder portion 23 is affixed in a central hole of the spacer 19, e.g. screwed or located so that the flanges 21, 22 hold the inner wall 7 clamped between them. In this way the hole 12 is tightly closed and if the intermediate space 9 between the vacuum insulation body 11 and the inner wall 7 is filled with foam, foam cannot pass through the hole 12 into the inner chamber 8.

If the foam is fixed in the intermediate space 16, the holder portion 23 can be loaded and can be used, for example to place a shelf thereon, to fix a telescopic rail for an extractable shelf or a removable container thereon, or the like.

The shape of the inner chamber 8 can be completely matched to the conventional merely foam-insulated refrigerator so that for a user no difference can be identified with the naked eye between the refrigerator according to the invention and a conventional refrigerator.

1-9. (canceled)

10. A housing for a refrigerator comprising a body and a door which is fixed to the body, both of which define an inner chamber, wherein at least one evacuated insulation body is formed by the body and the door, wherein an inner wall made of a plastic material is mounted in front of the insulation body towards the inner chamber.

11. The housing according to claim 10, wherein the insulation body is separated from the inner chamber at least locally by an intermediate space.

12. The housing according to claim 11, wherein the intermediate space is foam-filled.

13. The housing according to claim 10, wherein the inner wall has at least one aperture.

14. The housing according to claim 13, wherein a cable is guided through the aperture.

15. The housing according to claim 13, wherein a holder for internal attachments is anchored in the aperture.

16. The housing according to claim 10, wherein the holder for internal attachments of the refrigerator is formed in one piece on the inner wall.

17. The housing according to claim 10, wherein the body is composed of a plurality of insulation bodies and a one-piece inner wall common to the insulation bodies between which inner wall and the insulation bodies heat-insulating material is inserted for foaming.

18. The housing according to claim 10, wherein the insulation body is formed of an at least approximately non-diffusive inner cladding and an outer cladding associated vacuum-tightly thereto, which are arranged with respect to one another to form an evacuated body space which is filled with evacuable heat-insulating material.

19. A refrigerator comprising:
a body and an inner chamber disposed within the body;
a vacuum insulation body forming at least a portion of the body and including an outer wall and an intermediate wall spaced apart from one another and forming a body space between the outer wall and intermediate wall, the body space being evacuated to at least partially provide a vacuum having a pressure lower than atmospheric pressure within the vacuum insulation body and a supporting element being disposed within the body space; and
an inner wall mounted on the intermediate wall of the vacuum insulation body facing the inner chamber and forming an intermediate space between the inner wall and the vacuum insulation body and an insulating foam being disposed within the intermediate space.

20. The refrigerator according to claim 19, wherein the body includes a top wall, bottom wall, two opposing side walls, and a rear wall, each of these walls including:
a vacuum insulation body including an outer wall and an intermediate wall spaced apart from one another and forming a body space between the outer wall and intermediate wall, the body space being evacuated to at least partially provide a vacuum having a pressure lower than atmospheric pressure within the vacuum insulation body and a supporting element being disposed within the body space; and
an inner wall mounted on the intermediate wall of the vacuum insulation body facing the inner chamber and forming an intermediate space between the inner wall and the vacuum insulation body and an insulating foam being disposed within the intermediate space.

21. The refrigerator according to claim 20, further comprising a door coupled to the body, the door including:
a door vacuum insulation body including an outer wall and an intermediate wall spaced apart from one another and forming a body space between the outer wall and intermediate wall, the body space being evacuated to at least partially provide a vacuum having a pressure lower than atmospheric pressure within the door vacuum insulation body and a supporting element being disposed within the body space; and
a door inner wall mounted on the intermediate wall of the door vacuum insulation body facing the inner chamber and forming an intermediate space between the door inner wall and the door vacuum insulation body and an insulating foam being disposed within the intermediate space.

22. The refrigerator according to claim 19, wherein the outer wall and intermediate wall of the vacuum insulation body are formed from a metal material.

23. The refrigerator according to claim 19, wherein the inner wall is formed from a plastic material.

24. The refrigerator according to claim 19, wherein the supporting element includes an open-pored foam material.

25. The refrigerator according to claim 19, wherein the insulating foam includes a closed-pored foam material.

26. The refrigerator according to claim 19, further comprising an aperture formed in the inner wall and a cable running through the intermediate space and extending through the aperture.

27. A refrigerator comprising:
a body including a top wall, bottom wall, two opposing side walls, and a rear wall, and an inner chamber disposed within the body;
a door coupled to the body;
each of the walls of the body and the door comprising:
a vacuum insulation body including an outer wall and an intermediate wall spaced apart from one another and forming a body space between the outer wall and intermediate wall, the body space being evacuated to at least partially provide a vacuum having a pressure lower than atmospheric pressure within the vacuum insulation body and a supporting element being disposed within the body space; and
an inner wall mounted on the intermediate wall of the vacuum insulation body facing the inner chamber and forming an intermediate space between the inner wall and the vacuum insulation body and an insulating foam being disposed within the intermediate space.

28. The refrigerator according to claim 27, wherein the outer wall and intermediate wall of the vacuum insulation body are formed from a metal material, and the inner wall is formed from a plastic material.

29. The refrigerator according to claim 27, wherein the supporting element includes an open-pored foam material, and the insulating foam includes a closed-pored foam material.
